(19) United States
(12) Patent Application Publication
(10) Pub. No.: US 2014/0030915 A1
(43) Pub. Date: Jan. 30, 2014

(54) PRESSURE HYPERFREQUENCY COAXIAL CONNECTOR FOR CONNECTING TWO PRINTED CIRCUIT BOARDS

(71) Applicant: RADIALL, Rosny Sous Bois (FR)

(72) Inventor: Yves PERRIN, SAINT NICOLAS DE MACHERIN (FR)

(73) Assignee: RADIALL, Rosny Sous Bois (FR)

(21) Appl. No.: 13/951,579

(22) Filed: Jul. 26, 2013

(30) Foreign Application Priority Data
Jul. 27, 2012 (FR) 1257333

(51) Int. Cl. H01R 9/05

(52) U.S. Cl. CPC H01R 9/05
USPC 439/578

(57) ABSTRACT

This microwave-frequency coaxial connector for connecting a first printed circuit board with a second printed circuit board comprises a first connection element designed to be put in contact with the first printed circuit board, and a second complementary connection element designed to be put in contact with the second printed circuit board. Each connection element comprises: a conductive body having an internal passage surrounding a central axis and comprising a first contact surface, a conductive rod extending along the central axis and comprising a second contact surface. The first contact surface and the second contact surface of the first connection element are arranged to exert respectively on the first contact surface and on the second contact surface of the second contact element a contact force the resultant of which has an axial component parallel to the central axis and oriented from the first connection element to the second connection element.

### CROSS-REFERENCE TO RELATED APPLICATION

The present application claims priority to French Patent Application No. 1257333 filed Jul. 27, 2012. This application is incorporated herein by reference in its entirety.

### FIELD OF THE INVENTION

The present invention concerns a microwave-frequency coaxial connector for connecting two printed circuit boards.

### BACKGROUND

Within the meaning of the present invention, a component is said to be “microwave frequency” when it is capable of functioning in the microwave-frequency range, for example at frequencies of between 1 GHz and 100 GHz. An element is “conductive” when it allows electric current to pass, unlike an “insulating” element.

A connector generally includes a first connection element designed to establish electrical contact with a second complementary connection element.

A microwave-frequency coaxial connection element generally includes a central conductor consisting of a conductive rod that defines a longitudinal axis of the connector, as well as an outer conductor disposed around the conductive rod and formed by a conductive body. The rod and body are separated radially by an insulator. The two connection elements are mechanically disconnectable from each other and, when they are fitted together, an electrical contact is established between the rods of the two connection elements on the one hand and between the bodies of the two connection elements on the other hand.

In the case of a microwave-frequency coaxial connector connecting two printed circuit boards by pressure, one end of the first connection element is generally fixed to the first printed circuit board while the other printed circuit board is not mechanically fixed to the connector. The second connection element is made mechanically integral with the first connection element while allowing electrical connection and disconnection, so as to prevent the connection elements from separating. One end of the second connection element opposite to the first connection element is intended to come into contact with the second printed circuit board.

When connected, the second printed circuit board or movable board is brought in contact with the second connection element so as to electrically connect the second board with the second connection element, which is then pushed against the first connection element. Auxiliary means provide the holding in position of the second printed circuit board close to the first printed circuit board, thus preventing the second connection element from disconnecting with respect to the first connection element and the second printed circuit board.

FR-A-2 905 528 discloses a microwave-frequency coaxial connector in which a first spring is interposed axially between the conductive rods of the connection elements. A second spring is interposed axially between the conductive body of the connection elements. The first connection element is fixed to the first printed circuit board. When the second printed circuit board is brought against the second connection element, the springs push the rod and the body of the second connection element against the second printed circuit board, in the opposite direction to the first connection element, so as to ensure satisfactory electrical contact between the second connection element and the second printed circuit board. The structure of this connector is relatively complex, in particular because of the use of springs. Furthermore, the size of this connector is not optimized.

US-A-2007/004276 discloses a microwave-frequency coaxial connector having two complementary connection elements.

The connection elements are not mechanically integral with each other. For example, a first connection element is mechanically integral with a coaxial cable while the other connection element is mechanically integral with a printed circuit board. In addition, the body and conductive rod of each connection element are mechanically integral with each other. Thus the connector according to US-A-2007/004276 is not designed to connect two printed circuit boards by pressure.

The geometry of the connector reduces the disconnection forces so as to facilitate the separation of the two connection elements when they are connected. Thus their service life is prolonged. However, the connector does not provide continuous mechanical pressure on a printed circuit board.

It is these drawbacks that the invention particularly sets out to remedy by proposing a board-to-board microwave-frequency coaxial connector that is simple in design and compact.

### SUMMARY

To this end, the subject matter of the invention is a pressure microwave-frequency coaxial connector for electrically connecting a first printed circuit board with a second printed circuit board. The connector includes a first connection element designed to be put in contact with the first printed circuit board and a second complementary connection element designed to be put in contact with the second printed circuit board. Each connection element includes:

a conductive body having an internal passage surrounding a central axis and having a first contact surface,
a conductive rod extending along the central axis and having a second contact surface.

The first contact surface and the second contact surface of the first connection element are arranged to exert respectively on the first contact surface and on the second contact surface of the second connection element a contact force the resultant of which has an axial component parallel to the central axis and oriented from the first connection element to the second connection element.

By virtue of the invention, the connection elements are held in contact with the printed circuit boards without requiring the addition of dedicated mechanical parts, which simplifies the design of the connector and reduces its size and cost.

According to advantageous but non-obligatory aspects of the invention, such a connector may incorporate one or more of the following technical features, taken in all permissible technical combinations:

The second connection element is free to move, along the central axis, with respect to the first connection element, between a non-compressed configuration in which the printed circuit boards are not connected and a compressed configuration in which the connector electrically connects the printed circuit boards and in which the contact forces thrust the second connection element in the opposite direction to the first connection element and against the second printed circuit board.

In the compressed configuration, the contact forces elastically deform, in a radial direction perpendicular to the central axis, firstly the body of the first connection element and/or of the second connection element and secondly the rod of the first connection element and/or of the second connection element.

In the compressed configuration, the elastic deformation of the body and of the rod of the first connection element and/or of the second connection element generates, by elastic return, a radial component for each contact force.

The body of the second connection element is housed, at least partly, in the internal passage of the first connection element and the radial component of the resultant of the contact force, at the level of the bodies of the connection elements, is oriented towards the central axis.

A first ratio having as its numerator the intensity of the axial component of one or other of the resultants of the contact forces and as its denominator the total intensity of this resultant of the contact forces, decreases as the second connection element progresses towards the first connection element, while a second ratio having as its numerator the intensity of the radial component of one or other of the resultants of the contact forces and as its denominator the total intensity of this resultant of the contact forces, increases in the same time.

The first contact surface of the first connection element and/or of the second connection element and the second contact surface of the first connection element and/or of the second connection element are oblique with respect to the central axis.

The intersection between a plane that includes the central axis and a plane tangent to each oblique contact surface defines a straight line that forms with the central axis an angle of between 5° and 40°, preferably between 10° and 35°.

The contact surfaces which, in the compressed configuration, come into contact with the oblique contact surfaces, have a radius of curvature of between 0.05 mm and 0.20 mm, preferably between 0.15 and 0.1 mm.

The conductive rod of the first connection element is hollow and the conductive rod of the second connection element is housed, at least partly, inside the hollow conductive rod.

The axial component of each contact force is present continuously during connection, as soon as the connector electrically connects the printed circuit boards.

The conductive body of one of the connection elements includes a stop preventing the conductive body of the other connection element from separating.

The conductive body of at least one of the connection elements is not mechanically fixed to the printed circuit board designed to be put in contact with this connection element.

The conductive body and the conductive rod of at least one of the connection elements are not mechanically integral in translation.

The conductive body of one of the connection elements is adapted to deform elastically, and the first contact surface of the other connection element is oblique with respect to the central axis.

The conductive rod of one of the connection elements is adapted to deform elastically, and the second contact surface of the other connection element is oblique with respect to the central axis.

### BRIEF DESCRIPTION OF THE DRAWINGS

The invention will be better understood and other advantages thereof will emerge more clearly in the light of the following description of five examples of a microwave-frequency coaxial connector according to the invention, given solely by way of example and made with reference to the accompanying drawings, in which:

FIG. 1 is a view in elevation, in half section, of a microwave-frequency coaxial connector according to the invention, in a non-compressed configuration, mounted between two printed circuit boards;

FIG. 2 is a view to a larger scale of the detail II in FIG. 1;

FIG. 3 is a longitudinal section of a first connection element forming part of the connector of FIG. 1;

FIG. 4 is a partial longitudinal section of a second connection element forming part of the connector of FIG. 1;

FIG. 5 is a partial longitudinal section of the connector of FIG. 1, in a cutting plane different from the one in FIG. 1 and in a configuration compressed by the second printed circuit board;

FIGS. 6 and 7 are views, to a larger scale, of the details VI and VII in FIG. 1;

FIGS. 8 and 9 are views, to a larger scale, of the details VIII and IX in FIG. 5;

FIGS. 10 to 13 are partial longitudinal sections of additional examples of a microwave-frequency coaxial connector according to the invention.

### DETAILED DESCRIPTION

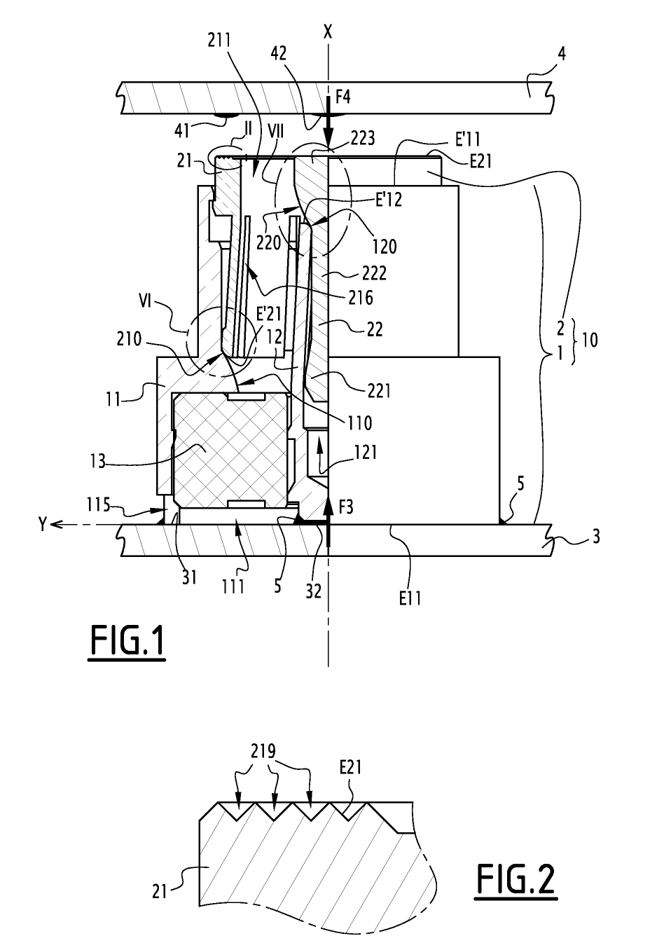

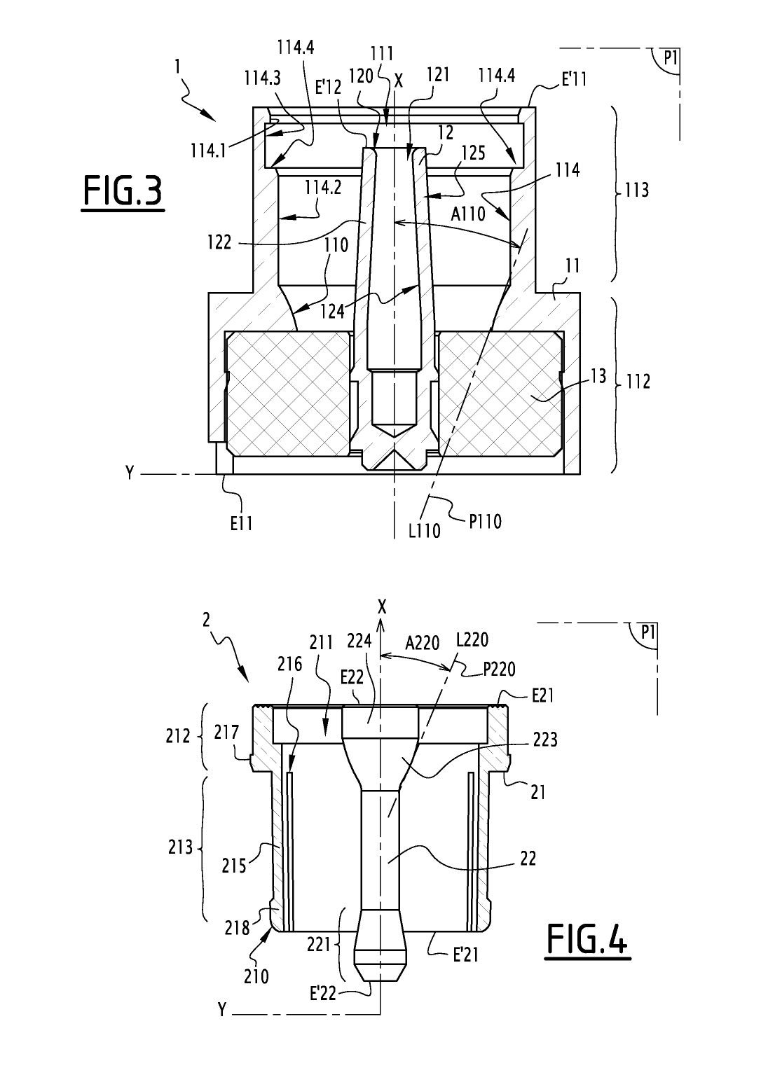

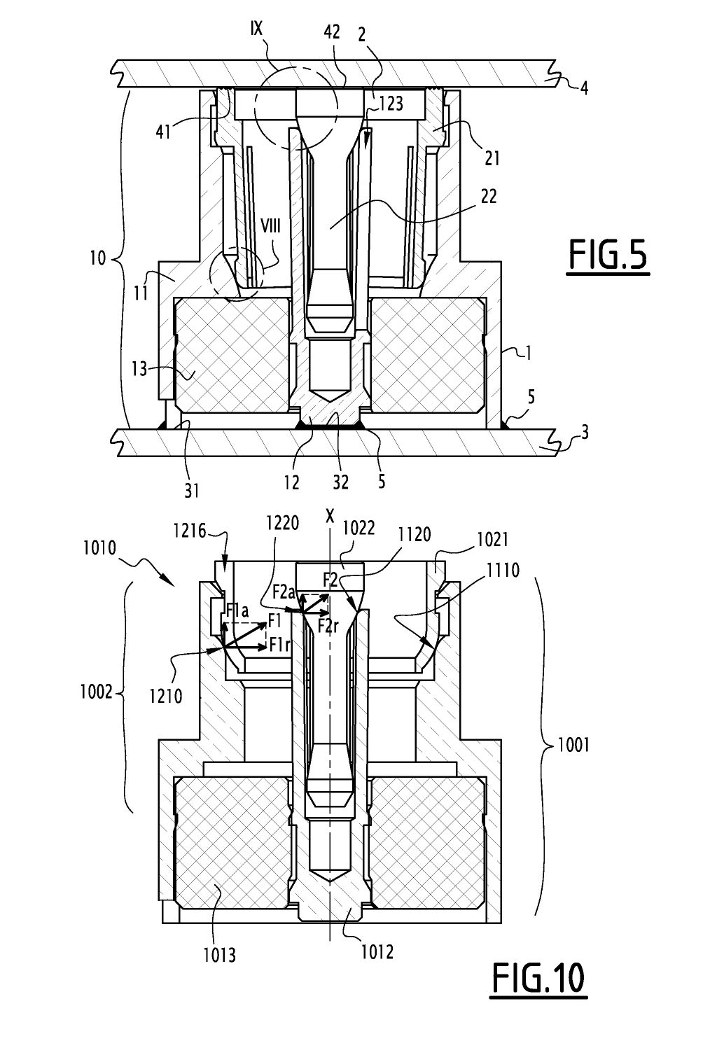

FIGS. 1 and 5 show a microwave-frequency coaxial connector 10 having a first connection element 1, shown separately in FIG. 3, as well as a second connection element 2 shown separately in FIG. 4.

The second connection element 2 is free to move, along a longitudinal central geometric axis X, with respect to the first connection 1, between a non-compressed configuration shown in FIG. 1 and a compressed configuration shown in FIG. 5, in which the connection elements 1 and 2 establish an electrical contact between a first printed circuit board 3 and a second printed circuit board 4.

The first connection element 1 is connected electrically to and fixed mechanically to the first printed circuit board 3 by a brazing 5. Thus, the connector 10 is a surface mounted component (SMC). The second connection element 2 is designed to come into electrical and mechanical contact with the second printed circuit board 4 but is not mechanically connected to the second printed circuit board 4.

The first connection element 1 includes a conductive body 11, a conductive rod 12, and an insulating ring 13 interposed radially between the body 11 and the rod 12. The elements 11, 12 and 13 each have overall a symmetry of revolution about the axis X of the connector 10. In FIGS. 4 and 5, the rod 12 is not shown in section.

The body 11 is overall in the form of a hollow cylinder with a circular cross-section, centered on the axis X and with a longitudinal passage 111 passing right through it, also centered on the axis X, surrounding the axis X and delimited by an internal wall 114 of the body 11.

Along the axis X, the body 11 includes a proximal end E11 in electrical and mechanical contact with the first printed circuit board 3, as well as a distal end E11 opposite to the proximal end E11.

The adjective “proximal” designates a part of the connection element 1 or 2 close, along the axis X, to the printed circuit board 3 or 4 to which this connection element 1 or 2 is connected, while the adjective “distal” designates an element that is further away therefrom. A surface is here termed “internal” when it is situated inside the connection element 1 or 2 and turned towards the axis X, while a surface is termed “external” when it is turned in an opposite direction, towards the outside of the connector 10. A radial direction YY is a direction perpendicular and secant to the axis X while an axial direction is parallel to the axis X.

The body 11 includes a proximal part 112 inside which the insulating ring 13 is housed, as well as a distal part 113 with a diameter less than the proximal part, in which the second connection element 2 is received.

At the proximal end E11, the body 11 includes a recess 115 enabling a microwave-frequency conductive track to pass, which connects the rod 12 to another electronic component of the first printed circuit board 3.

An internal contact surface 110, rounded and convex, forming part of the internal wall 114, is situated at the junction between the parts 112 and 113 of the body 11. The diameter of the contact surface 110 of the body 11 decreases, along the axis X, in a direction going from the distal end E11 to the proximal end E11 of the body 11.

The distal end of the contact surface 110 of the body 11 is contiguous with a middle part 114.2 of the internal wall 114 having a constant diameter along the axis X. At the distal end E11 of the body 11, the middle part 114.2 of the internal wall 114 is contiguous with an internal peripheral annular groove 114.3 formed in the distal part 113 of the body 11. A shoulder 114.4 perpendicular to the axis X is formed between the middle part 114.2 and the groove 114.3. At the distal end E′11 of the body 11, the groove 114.3 is delimited by a peripheral annular stop 114.1 that projects radially towards the inside of the body 11.

The contact rod or sleeve 12 of the first connection element 1 is centered on the axis X and includes a blind hole 121 also centered on the axis X. The rod 12 includes a proximal end E12 and a distal end E′12 that is recessed in the body 11. The hole 121 emerges at the distal end E′12 of the rod 12. The rod 12 is formed by a wall 122 of roughly constant thickness, delimited by an internal wall 124 and by an external surface 125 both also frustoconical. The wall 122 includes several longitudinal slots 123, one of which is visible in the plane in FIG. 5, parallel to the axis X and each emerging at the distal end E′12 of the rod 12.

An internal contact surface 120, rounded and convex, forms the distal end of the internal wall 124 of the rod 12. The diameter of the contact surface 120 decreases along the axis X, in a direction going from the distal end E′12 to the proximal end E12 of the rod 12.

As can be seen in FIG. 4, the second connection element 2 includes a conductive body 21 received in the distal part 113 of the body 11 of the first connection element 1, as well as a conductive rod 22 received in the hole 121 of the rod 12 of the first connection element 1. The body 21 and the rod 22 of the second connection element 2 are not mechanically integral with each other and each has roughly a symmetry of revolution about the axis X.

The body 21 has roughly the form of a hollow cylinder with a circular cross-section, centered on the axis X and with a longitudinal passage 211 passing through it, also centered on the axis X and surrounding the axis X. Along the axis X, the body 21 includes a proximal end E21 designed to come into electrical and mechanical contact with the second printed circuit board 2, as well as a distal end E′21 opposite to the proximal end E21.

The body 21 includes a proximal part 212 and a distal part 213 with a diameter less than the proximal part 212. The proximal part 212 includes an external peripheral collar 217 that is housed in the groove 114.3 of the body 11 of the first connection element 1 and the outside diameter of which is substantially equal, to within functional clearances, to that of the bottom of the groove 114.3. The distal part 213 of the body 21 of the second connection element 2 is formed by a hollow frustoconical wall 215 that includes longitudinal slots 216 parallel to the axis X. The slots 216 do not extend over the entire length of the body 21 and emerge towards the outside only at the distal end E′21 of the body 21. In the absence of any external mechanical action on the second connection element 2, the diameter of the wall 215 is constant along the axis X, as can be seen in FIG. 4. In a variant that is not shown, the diameter of the wall 215 increases, along the axis X, between the proximal end E21 and the distal end E′21 of the body 21 of the second connection element 2.

The wall 215 includes a protruding contact part 218 that forms the distal end E′21 of the body 21. The contact part 218 is delimited by an external contact surface 210, rounded and convex. The maximum diameter of the contact surface 210 is substantially equal to, or slightly greater than, that of the middle part 114.2 of the internal wall 114 of the body 11 of the first connection element 1, so as to provide electrical contact between the bodies 11 and 21 of the connection elements 1 and 2.

As can be seen in FIG. 2, the proximal end E21 of the body 21 of the second connection element 2 includes serrations 219 that confer a rough appearance on the body 21.

The rod 22 of the second connection element 2 includes a proximal end E22 and a distal end E′22 that projects, along the axis X, outside the body 21 of the second connection element 2.

The rod 22 is solid, that is to say it does not have any bore centered on the axis X, and no part of the rod 22 is designed to deform elastically.

The rod 22 includes a distal part 221 that overall is in the form of an ellipsoid, the distal end of which is truncated. The rod 22 also includes a middle part 222, the diameter of which is constant and less than or equal to the maximum diameter of the distal part 221. The rod 22 includes a curved contact part 223, roughly in the form of a semi-ellipsoid, contiguous with the middle part.

The contact part 223 is delimited by an external contact surface 220, curved and convex. The diameter of the contact surface 220 decreases, along the axis X, in a direction going from the proximal end E22 towards the distal end E′22 of the rod 22.

The contact part 223 is extended, along the axis X and opposite to the middle part 222, by a proximal part 224 of constant diameter. The proximal end E22 of the rod 22 includes serrations similar to the serrations 219 on the body 21, not visible in the figures, which confer a rough appearance on the rod 22.

Thus, each connection element 1 and 2 includes a first contact surface 110 or 210 carried by the body 11 or 21 or this connection element 1 or 2, as well as a second contact surface 120 or 220 carried by the rod 12 or 22 of this connection element 1 or 2.

The contact surfaces 110 and 120 of the first connection element 1 are internal, while the contact surfaces 210 and 220 of the second connection element 2 are external. With regard to the first connection element 1, the convex side of this curved line is turned roughly towards the axis X. Conversely, with regard to the second connection element 2, the convex side of this curved line is turned roughly in the opposite direction to the axis X.

In service, the first and second contact surfaces 110 and 120 of the first connection element 1 come into electrical and mechanical contact with respectively the first and second contact surfaces 210 and 220 of the second connection element 1.

The contact surfaces 110 and 220 of the connection elements 1 and 2 are oblique with respect to the axis X. In the case where the contact surfaces 110 and 220 are curved, as in the example in the figures, the term “oblique” means that a plane tangent to a middle region of the contact surface 110 or 220 is inclined with respect to the axis X. In a variant that is not shown, at least one contact surface 110 or 220 is plane. In this case, the term “oblique” means that this contact surface is inclined with respect to the axis X, for example by an angle of approximately 20°.

The oblique contact surfaces 110 and 220 are formed by the rotation over 360°, about the axis X, of a curved line, for example an arc of a circle.

As shown by FIG. 3, the intersection between a longitudinal plane P1 that includes the axis X and a plane P110 tangent to the first contact surface 110 of the body 11 of the first connection element 1 defines a straight line L110 that forms with the axis X an angle A110 situated, along the axis X, on the same side as the distal end E11 of the body 11 and on the same side as the second connection element 2 with respect to the intersection between the axis X and the straight line L110. The angle A110 may be between 5° and 40°, preferably between 10° and 35°. The plane P1 corresponds to the plane of FIGS. 1 to 9.

In addition, the intersection between the plane P1 and a plane P220 tangent to the second contact surface 220 of the rod 22 of the second contact element 2 defines a straight line L220 that forms with the axis X an angle A220 situated, along the axis X, on the same side as the proximal end E22 of the rod 22 and on the same side as the second connection element 2 with respect to the intersection between the axis X and the straight line L220. The angle A220 may be between 5° and 40°, preferably between 10° and 35°.

The angles A110 and A220 are determined according to the coefficient of friction of the materials forming the connection elements 1 and 2.

The axes X and Y form an orthogonal reference frame. A positive direction is defined for the axis X going from the second printed circuit board 4 to the first printed circuit board 3. A positive direction is defined for the axis Y going from the axis X towards the outside.

In the reference frame (X, Y), that is to say in the plane P1, the slope of the first oblique contact surface 110 is negative and increases along the axis X, in the positive direction, that is to say as progressing from the second connection element 2 in the first connection element 1. In other words, the curve that defines the first oblique contact surface 110 is decreasing. Its derivative is negative and increases along the axis X, in the positive direction. It is considered here that the axis Y intersects the first oblique contact surface 110.

In the reference frame (X, Y), that is to say in the plane P1, the slope of the second oblique contact surface 220 is negative and decreases along the axis X, in the positive direction, that is to say as progressing from the second connection element 2 in the first connection element 1. In other words, the curve that defines the second oblique contact surface 220 is decreasing. Its derivative is negative and decreases along the axis X, in the positive direction. It is considered here that the axis Y cuts the second oblique contact surface 220.

The contact surface 120 of the rod 12 of the first connection element 1 is rounded and its radius of curvature is equal to approximately 0.1 mm. In addition, the contact surface 210 of the body 21 of the second connection element 2 is rounded and its radius of curvature is approximately equal to 0.15 mm. Preferably, the radii of curvature of the contact surfaces 120 and 210 are between 0.05 and 0.2 mm.

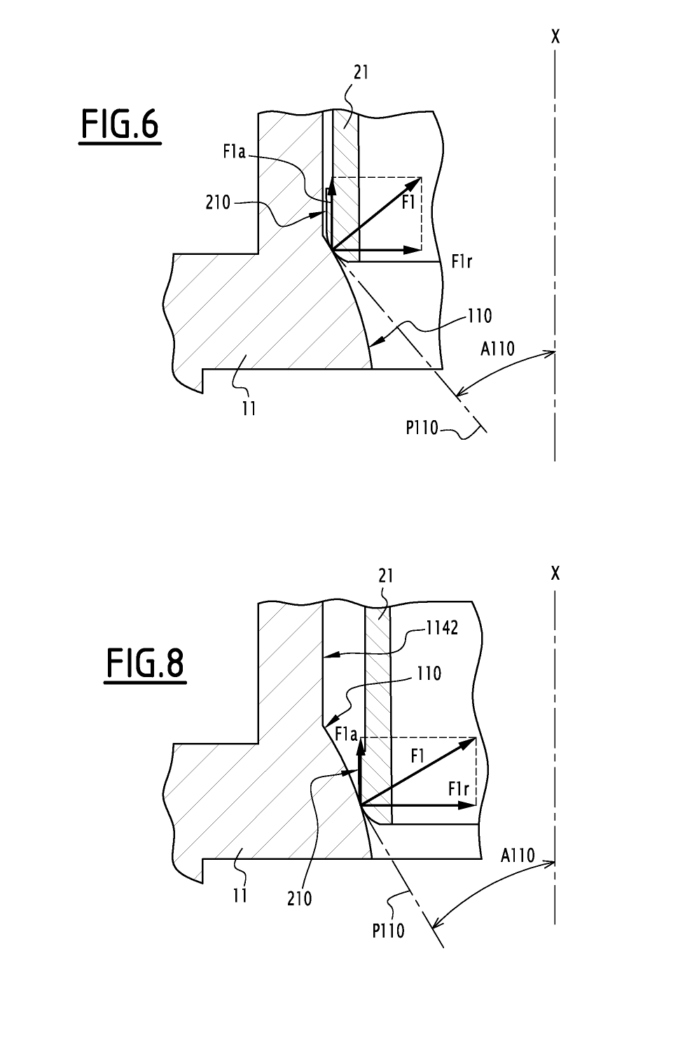

The first contact surface 110 of the first connection element 1 is arranged to exert, on the first contact surface 210 of the second connection element 2, contact forces, the resultant F1 of which is shown in FIGS. 6 and 8. These contact forces may be linear or surface forces according to the forms of the first contact surfaces 110 and 210.

In a radial direction Y with respect to the axis X, the resultant F1 has a radial component F1r, directed towards the axis X, which guarantees a radial pressure between the bodies 11 and 21 of the connection elements 1 and 2. The resultant F1 also has an axial component F1a that is parallel to the axis X and is oriented from the distal end E′21 of the body 21 of the second connection element 2 towards the proximal end E21 of the body 21, that is to say from the first printed circuit board 3 towards the second printed circuit board 4 or from the first connection element 1 towards the second connection element 2.

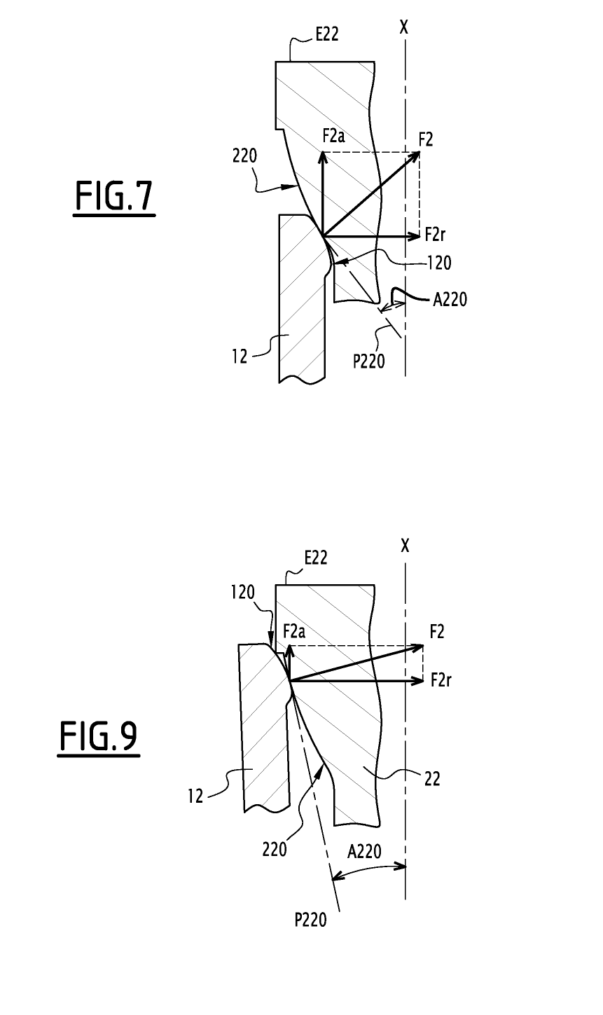

The second contact surface 120 of the first connection element 1 is arranged to exert, on the second contact surface 220 of the second connection element 2, contact forces the resultant F2 of which is shown in FIGS. 7 and 9. These contact forces may be linear or surface forces according to the forms of the contact surfaces 120 and 220.

In a radial direction Y with respect to the axis X, the resultant F2 has a radial component F2r, directed towards the axis X, that guarantees a radial pressure between the rods 12 and 22 of the connection elements 1 and 2. The resultant F2 also has an axial component F2a that is parallel to the axis X and is oriented from the distal end E′22 of the rod 22 of the second connection element 2 towards the proximal end E22 of the rod 22, or in other words from the first connection element 1 towards the second connection element 2.

Thus the first contact surface 110 and the second contact surface 120 of the first connection element 1 are arranged to exert, respectively on the first contact surface 210 and on the second contact surface 220 of the second connection element 2, a contact force, the resultant F1 or F2 of which has a component F1a or F2a parallel to the central axis X and oriented from the first connection element 1 towards the second connection element 2.

Before the electrical connection of the printed circuit boards 3 and 4, the connector 10 is in the non-compressed configuration (FIG. 1), in which the second printed circuit board 4 is not in contact with the connector 10. The body 21 of the second connection element 2 is not mechanically loaded. The connection part 218 of the body 21 of the second connection element 2 is in abutment against the large-diameter end of the first connection surface 110 of the body 11 of the first connection element 1. The collar 217 of the second connection element 2 is guided in the recess 114.3 of the body 11 of the first connection element 1. The stop 114.1 prevents the body 21 of the second connection element 2 from separating from the first connection element 1 in the event of turning over of the connector 10.

In the non-compressed configuration, the parts 221 and 222 of the rod 22 of the second connection element 2 are housed inside the hole 121 of the rod 12 of the first connection element 1. The proximal part 223 of the rod 22 of the second connection element 2 is in abutment against the distal end E′12 of the rod 12 of the first connection element 1.

When the printed circuit boards 3 and 4 are electrically connected, the second printed circuit board 4 is pushed in the direction of the first printed circuit board 3, in contact with the second connection element 2. This push F4 parallel to the axis X is shown in FIG. 1. The first printed circuit board 3 is fixed and rests for example on a support. The push F4 thus generates by reaction a push F3, in the opposite direction, applied by the first printed circuit board 3 on the first connection element 1.

The second printed circuit board 4 thus conjointly thrusts the body 21 and the rod 22 of the second connection element 2 towards the first printed circuit board 3, so that the first contact surface 210 of the second connection element 2 slides against the first contact surface 110 of the first connection element 1. The serrations 219 on the body 21 and rod 22 of the second connection element 2 improve the electrical contact between the second printed circuit board 4 and the second connection element 2. This is because the contact pressure is increased by the reduction in the contact surface.

The distal part 213 of the body 21 of the second connection element 2 compresses elastically by virtue of the slots 216 in a radial direction Y, so as to allow a movement, towards the axis X, of the connection part 218 of the second connection element 2. The rigidity of the body 21 is satisfactory since the slots 216 do not extend over its entire length, which is not detrimental to the quality of the microwave-frequency signal transmitted.

The collar 217 of the body 21 of the second connection element 2 slides simultaneously in the groove 114.3 of the body 11 of the first connection element 1 until it comes into abutment against the shoulder 114.4 of the body 11 of the first connection element 1.

At the same time, the second printed circuit board 4 pushes the rod 22 of the second connection element 2 towards the bottom of the hole 121 of the rod 12 of the first connection element 1, so that the second contact surface 220 of the second connection element 2 slides against the second contact surface 120 of the first connection element 1.

The wall 122 of the rod 12 of the first connection element 1 deforms elastically by virtue of the slots 123 so as to allow a radial movement, opposite to the axis X, of the contact part 223 of the rod 12 of the first connection element 1.

The connector 10 is then again in the compressed configuration (FIG. 5) and an electrical and mechanical contact is established, firstly between the bodies 11 and 21 of the connection elements 1 and 2, at the first contact surfaces 110 and 210, and secondly between the rods 12 and 22 of the connection elements 1 and 2, at the second contact surfaces 120 and 220.

In the compressed configuration, the second printed circuit board 4 is held fixed with respect to the first printed circuit board 3 by means of an auxiliary mechanical device, not shown. The pushes F3 and F4 and the elastic return forces of the rod 12 of the first connection element 1 and of the body 21 of the second connection element 2 give rise firstly to the first resultant F1, at the first contact surfaces 110 and 210, and secondly to the second resultant F2, at the second contact surfaces 120 and 220.

In other words, in the compressed configuration, the deformation of the body 21 and of the rod 12 generates, by elastic return, a radial component F1r and F2r for each contact force F1 and F2.

By virtue of the axial components F1a and F2a of the resultants F1 and F2, directed from the first printed circuit board 3 towards the second printed circuit board 4, the second connection element 2 is pushed by the first connection element 1 against the second printed circuit board 4, in the opposite direction to the first connection element 1 and the first printed circuit board 3, which guarantees strong electrical and mechanical contact between the second connection element 2 and the second printed circuit board 4, and makes it possible to transmit a microwave-frequency electrical signal between the printed circuit boards 3 and 4 in a satisfactory manner.

The axial components F1a and F2a of the resultants F1 and F2 are non-zero all along the connection of the first connection element 1 with the second connection element 2 as soon as the connector electrically connects the printed circuit boards.

More precisely, in the compressed configuration, firstly the body 11 and the rod 12 of the first connection element 1 are respectively in electrical and mechanical contact with a first roughly annular conductive track 31 and a second circular conductive track 32 of the first printed circuit board 3 and secondly the body 21 and the rod 22 of the second connection element 2 are respectively in electrical and mechanical contact with a first annular conductive track 41 and a second circular conductive track 42 of the second printed circuit board 4. The first conductive track 31 may comprise an opening for the passage of a conductive track connected to the rod 12 of the first connection element 1.

The rod 22 of the second connection element 2 is free to slide in the rod 12 of the first connection element 1, independently of the movement of the body 21 of the second connection element 2 with respect to the first connection element 1. The second connection element 2 does not comprise any insulating element providing the holding of the rod 22 with respect to the body 21. In other words, the rod 22 of the second connection element 2 is free to move in translation and rotation with respect to the body 21 of the second connection element 2. Thus optimum contact between the conductive tracks 41 and 42 and the body 21 of the rod 22 of the second connection element 2 is ensured.

In a variant, the body 21 and the rod 22 are mechanically integral with respect to rotation.

Given that the rod 22 and the body 21 of the second connection element 2 are not mechanically integral, it is essential that the first connection element 1 and the second connection element 2 comprise both a first contact surface 110 and 210 in order to provide an optimum connection between the bodies 11 and 21, and a second contact surface 120 and 220 for providing an optimum connection between the rods 12 and 22.

The first conductive track 31 of the first printed circuit board 3 is electrically connected to the first conductive track 41 of the second printed circuit board 4 by means of the bodies 11 and 21 of the connection elements 1 and 2. The second conductive track 32 of the first printed circuit board 3 is electrically connected to the second conductive track 42 of the second printed circuit board 4 by means of the rods 12 and 22 of the connection elements 1 and 2.

The connection elements 1 and 2 are held in contact with the printed circuit boards 3 and 4 without requiring the addition of dedicated mechanical parts, in particular springs, which simplifies the design of the connector 10 and reduces its size and cost.

The angle A110 increases, along the axis X, between the proximal end E11 and the distal end E11 of the body 11 of the first connection element 1. Likewise, the angle A220 increases, along the axis X, between the proximal end E22 and the distal end E′22 of the rod 22 of the second connection element 2. In other words, the angles A110 and A220, measured at the contact area between the first and second connection elements 1 and 2, increase as the second connection element 2 progresses towards the first connection element 1. The angles A110 and A220 are approximately equal to 35° in the configuration in FIG. 1 and are approximately equal to 10° in the configuration in FIG. 5.

Consequently, the relative intensity of the axial component F1a or F2a of the pushes F1 and F2 decreases as the second connection element 2 progresses towards the first connection element 1, while the relative intensity of the radial component F1r or F2r of the thrusts F1 or F2 increases at the same time.

As is clear from the comparison between FIGS. 6 and 8, the relative intensity of the axial component F1a of the resultant F1, with respect to the total intensity of the resultant F1, is greater in the non-compressed configuration (FIG. 6) than in the compressed configuration (FIG. 8). In other words, a first ratio having as its numerator the intensity of the axial component F1a of the resultant F1 and as its denominator the total intensity of this resultant F1, decreases as the second connection element 2 progresses towards the first connection element 2.

At the same time, as is clear from the comparison between FIGS. 7 and 9, the relative intensity of the axial component F2a of the resultant F2, with respect to the intensity of the resultant of the resultant F2, is greater in the non-compressed configuration (FIG. 7) than in the compressed configuration (FIG. 9). In other words, a second ratio having as its numerator the intensity of the radial component F2r of the thrust F2 and as its denominator the total intensity of this resultant F2, increases as the second connection element 2 progresses towards the first connection element 2.

Moreover, the elastic deformation of the rod 12 of the first connection element 1 and of the body 21 of the second connection element 2 increases as the second connection element 2 progresses in the first connection element 1. Consequently, the elastic return forces exerted firstly by the rod 12 of the first connection element 1 on the rod 22 of the second connection element 2 and secondly by the body 21 of the second connection element 2 on the body 11 of the first connection element 1 increases as the first connection element 2 progresses in the first connection element 1. In this way, the total intensity of the resultants F1 and F2 increases as the second connection element 2 progresses in the first connection element 1.

The geometry of the connector 10 implies that the axial component Fa1 or Fa2 of the resultant F1 and of the resultant F2 varies between approximately 1 and 10 N or respectively between approximately 0.2 and 2 N, when the connection elements 1 and 2 are connected or disconnected. These forces are sufficient to ensure satisfactory electrical contact between the connection elements 1 and 2.

In this way, the connection of the printed circuit boards is facilitated at the start of connection because of the high intensity of the axial components F1a and F2a compared with the radial components F1r and F2r of the thrusts F1 and F2. When the printed circuit boards 3 and 4 are connected, the connector 10 has good mechanical stability because of the low intensity of the axial components F1a and F2a with respect to the radial components F1r and F2r of the thrusts F1 and F2.

The second contact surfaces 120 and 220 are carried respectively by the rods 12 and 22 of the connection elements 1 and 2. The rod 22 of the second connection element 2 is solid and non-elastic and carries the first oblique contact surface 220, while the rod 12 of the first connection element 1 is an elastically deformable sleeve, since it is hollow and includes a central hole 121 as well as longitudinal slots 123 that delimit petals elastically deformable in a radial direction 15, 16. In this way, the conductive rod 12 of the first connection element 1 is adapted to deform elastically, and the second contact surface 220 of the second connection element 2 is oblique with respect to the central axis X. In a variant that is not shown, the conductive rod 22 of the second connection element 2 is adapted to deform elastically, and the second contact surface 120 of the first connection element 1 is oblique with respect to the central axis X.

In the same way, the conductive body 11 or 21 of one of the connection elements 1 or 2 is adapted to deform elastically, and the first contact surface 110 or 210 of the other connection element 2 or 1 is oblique with respect to the central axis X.

FIGS. 10, 11, 12 and 13 show respectively connectors 1010, 2010, 3010 and 4010 in accordance with other examples of the invention. The elements of the connectors 1010, 2010, 3010 and 4010 similar to those of the connection element 10 in FIGS. 1 to 9, bear the same numerical references, increased respectively by 1000, 2000, 3000 and 4000. Hereinafter, the elements of the connectors 1010, 2010, 3010 and 4010 similar to those of the connector 10 are not described in detail.

Thus each connector 1010, 2010, 3010 and 4010 includes a first connection element 1001, 2001, 3001 or 4001 as well as a second connection element 1002, 2002, 3002 or 4002 free to slide, to a limited extent, inside the first connection element 1001, 2001, 3001 or 4001. The connection elements 1001, 2001, 3001 or 4001 and 1002, 2002, 3002, or 4002 are designed to establish electrical contact between a first printed circuit board and a second printed circuit board, not shown.

Each first connection element 1001, 2001, 3001 and 4001 includes a conductive body 1011, 2011, 3011 or 4011, a conductive rod 1012, 2012, 3012 or 4012 and an insulating ring 1013, 2013, 3013 or 4013, interposed radially between the body 1011, 2011, 3011 or 4011 and the rod 1012, 2012, 3012 or 4012 of the first connection element 1001, 2001, 3001 or 4001.

Each second connection element 1002, 2002, 3002 and 4002 includes a conductive body 1021, 2021, 3021 or 4021 as well as a conductive rod 1022, 2022, 3022 or 4022 each having roughly a symmetry of revolution about an axis X.

Each first connection element 1001, 2001, 3001 and 4001 and each second connection element 1002, 2002, 3002 and 4002 includes a first contact surface 1110, 2110, 3110 or 4110 and respectively 1210, 2210, 3210 or 4210, carried by the body 1011, 2011, 3011 or 4011 and respectively 1021, 2021, 3021 or 4021, of this connection element, as well as a second contact surface 1120, 2120, 3120 or 4120 and respectively 1220, 2220, 3220 or 4220, carried by the rod 1012, 2012, 3012 or 4012 and respectively 1022, 2022, 3022 or 4022 of this connection element.

The first contact surface 1110, 2110, 3110 or 4110 and the second contact surface 1120, 2120, 3120 or 4120 of the first connection element 1001, 2001, 3001 are arranged so as to exert, respectively on the first contact surface 1210, 2210, 3210 or 4210 and on the second contact surface 1220, 2220, 3220 or 4220 of the second connection element 1002, 2002, 3002 or 4002, a contact force the resultant F1 or F2 of which has an axial component F1a or F2a parallel to the central axis X and oriented from the first connection element 1 towards the second connection element 2, as well as a radial component F1r or F2r oriented towards the axis X.

The body 1021 of the second connection element 1002 of the connector 1010 shown in FIG. 10 includes a single longitudinal slot 1216 which, unlike the slots 216 of the connector 10, emerge on either side of the body 1021. This geometry is less favorable than that of the body 21 of the connector 10 for transmitting the microwave-frequency signals.

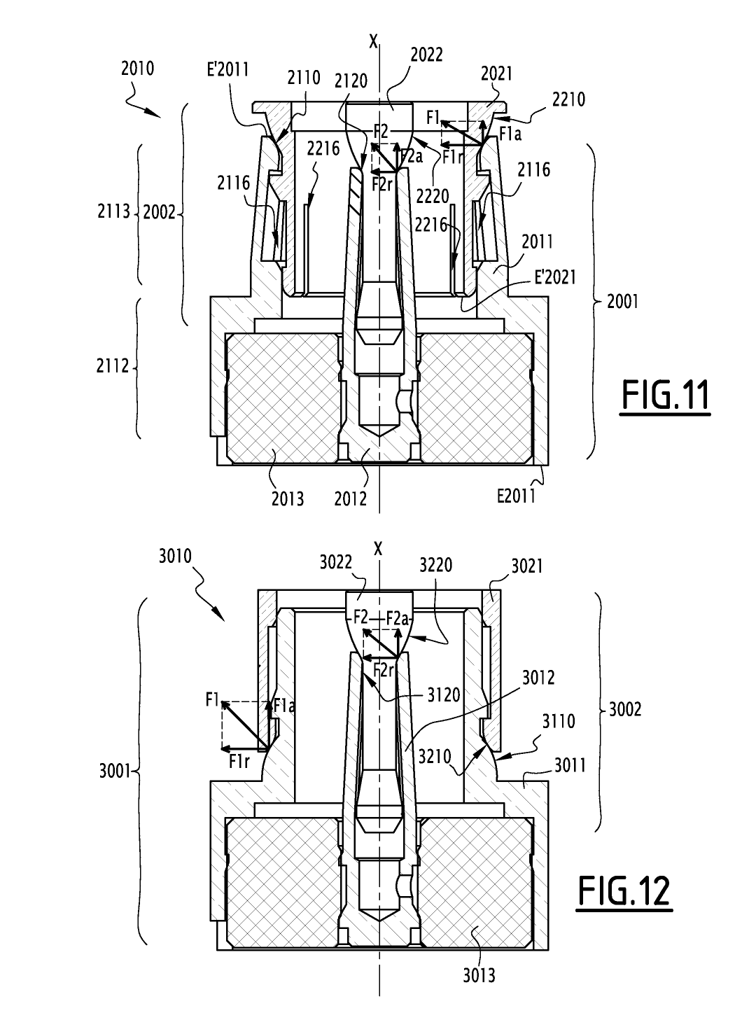

The body 2011 of the first connection element 2001 of the connector 2010 shown in FIG. 11 includes a proximal part 2112 and a distal part 2113 and is distinguished more particularly from the connector 10 by the fact that the distal part 2113 is frustoconical and includes longitudinal slots 2116 emerging only on the same side as a distal end E′2011 of the body 2011. The diameter of the distal part 2113 increases, along the axis X, between the distal end E′2011 and a proximal end E2011 of the body 2011 of the first connection element 2001.

The body 2021 of the second connection element 2002 also includes longitudinal slots 2216 similar to the slots 216 in the connector 10.

Unlike the connector 10, the first contact surface 2110 of the body 2011 of the first connection element 2001 is situated at the distal end E′2011 of the body 2001.

In service, the bodies 2011 and 2021 of the connection elements 2001 and 2002 deform elastically, in a radial direction Y, by virtue of the slots 2116 and 2216, in order to guarantee strong contact between the bodies 2011 and 2021.

The connector 3010 shown in FIG. 12 is distinguished more particularly from the connector 10 by the fact that the body 3021 of the second connection element 3002 is mounted around the body 3011 of the first connection element 3001, outside the first connection element 1. Thus the first contact surface 3110 of the body 3011 of the first connection element 3001 is an external surface and the first contact surface 3210 of the second connection element 3002 is an internal surface. The radial component F1r of the first thrust F1 is therefore oriented opposite to the axis X.

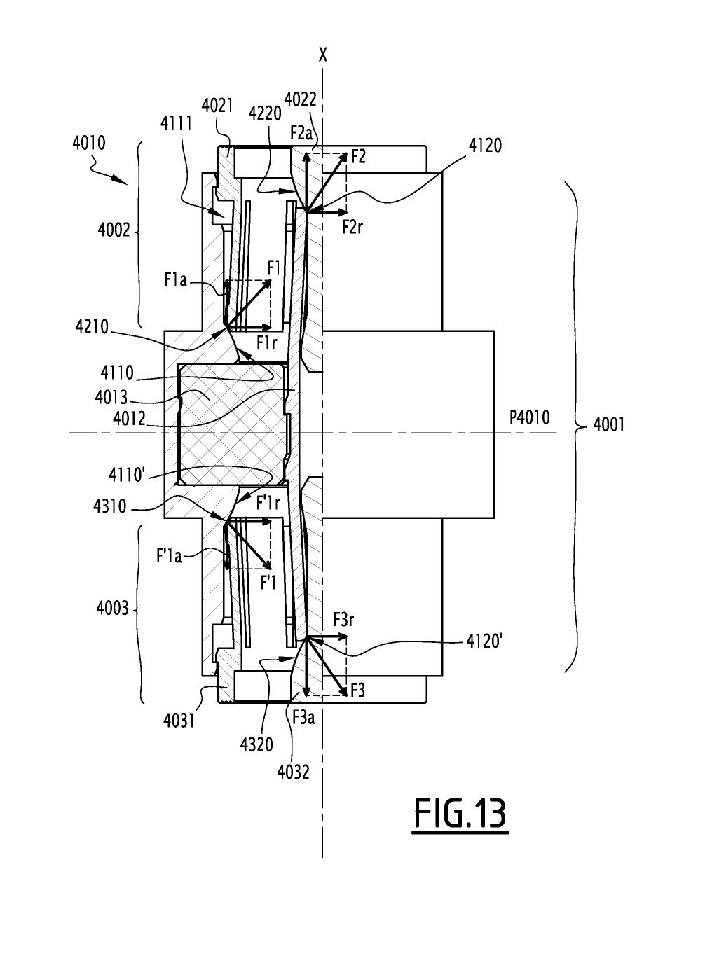

The connector 4010 shown in FIG. 13 includes, apart from the first connection element 4001 and the second connection element 4002, a third connection element 4003 having a geometry similar to that of the second connection element 4002 and free to slide, in a limited fashion, inside the first connection element 4001. The third connection element 4003 is mounted in a central passage 4111 in the first connection element 4001, opposite to the second connection element 4002. Thus the connector 4010 is roughly symmetrical with respect to a plane P4010 perpendicular to the axis X and passing between the connection elements 4002 and 4003.

The first connection element 4001 is designed to be put in contact with the first printed circuit board 3, by means of the third connection element 4003, which includes a conductive body 4031 and a conductive rod 4032.

The third connection element is provided with a first contact surface 4310 carried by the conductive body 4031 and a second contact surface 4320 carried by the conductive rod 4032.

The first connection element 4001 includes a first auxiliary contact surface 4110′ carried by the body 4011, and a second auxiliary contact surface 4120′ carried by the rod 4012, arranged to exert, respectively on the first contact surface 4310 and on the second contact surface 4320 of the third connection element 4003, a contact force having a resultant F′1 and respectively F3. The resultants F′1 and F3 each have firstly an axial component F′1a and respectively F3a, parallel to the axis X, oriented from the first connection element 4001 towards the third connection element 4003 and the first printed circuit board 3, opposite to the resultants F1 and F2, and, secondly, a radial component F′1r and respectively F3r, oriented towards the axis X. This ensures strong contact between the third connection element 4003 and the first printed circuit board 3, in the case where the connector 4003 is not mechanically fixed to the first printed circuit board 3.

In a variant that is not shown, the rod 12 and 22 of each connection element 1 and 2 is elastically deformable in a radial direction Y. Thus, in the compressed configuration, the contact forces F1 and F2 elastically deform, in a radial direction Y, the rod 12 and 22 of each connection element 1 and 2.

In the examples shown in FIGS. 1 to 12, the first connection element 1, 1001, 2001 and 3001 is electrically connected to, and mechanically fixed on, the first printed circuit board 3, while the second connection element 2, 1002, 2002, 3002 is not mechanically assembled on the second printed circuit board 4. In a variant that is not shown, the first connection element is not mechanically assembled on the first printed circuit board 3, while the second connection element is electrically connected to, and mechanically fixed on, the second printed circuit board 4. In the variant in FIG. 13, the three connection elements 4001, 4002 and 4003 are not mechanically assembled on the printed circuit board 3 or 4 designed to be put in contact with this connection element. Thus at least one of the connection elements 4001, 4002 and 4003 is not mechanically assembled on the printed circuit board 3 or 4 designed to be put in contact with this connection element.

In the examples shown in FIGS. 1 to 9, the stop 114.1 preventing the body 21 of the second connection element 2 from separating from the first connection element 1 in the event of the connector 10 being turned upside down, is carried by the first connection element 1. In a variant, the second connection element 2 includes such a stop. As can be seen in the figures, the body 11 of the first connection element 1 includes a complementary stop that cooperates with the stop 114.1 in order to prevent the bodies 11 and 21 from separating.

The connectors 10, 1010, 2010, 3010 and 4010 shown in the figures are designed to minimize the variations in impedance.

In the examples shown in FIGS. 1 to 9 and 13, the first contact area between the first contact surfaces 110 and 210 and the second contact area between the second contact surfaces 120 and 220 are offset with respect to each other, along the central axis X, which minimizes the discontinuities in the air of the internal passage 111, 211 where the signal propagates.

In the example shown in FIG. 10, the first contact surface 1110 of the first connection element 1001 is relatively short along the central axis X. In other words, the height of the first contact surface 1110, measured along the central axis X, is small.

In the examples shown in FIGS. 11 and 12, the first contact area between the first contact surfaces 2110 and 2210 or 3110 and 3210 is situated outside the internal passage in the first connection element 3001, in which the signal propagates. Thus the first contact area does not interfere with the signal.

Furthermore, in the context of the invention, the various examples and variants can be combined with each other, at least partially.

1. A pressure microwave-frequency coaxial connector electrically connecting a first printed circuit board with a second printed circuit board, the connector comprising a first connection element designed to be put in contact with the first printed circuit board and a second complementary connection element designed to be put in contact with the second printed circuit board, each connection element comprising:
a conductive body having an internal passage surrounding a central axis and comprising a first contact surface,
a conductive rod extending along the central axis and comprising a second contact surface,
wherein the first contact surface and the second contact surface of the first connection element are arranged to exert respectively on the first contact surface and on the second contact surface of the second convection element a contact force the resultant of which has an axial component parallel to the central axis and oriented from the first connection element to the second connection element.

2. The connector according to claim 1, wherein the second connection element is free to move, along the central axis, with respect to the first connection element, between a non-compressed configuration in which the printed circuit boards are not connected and a compressed configuration in which the connector electrically connects the printed circuit boards and in which the contact forces push the second connection element in the opposite direction to the first connection element and against the second printed circuit board.

3. The connector according to claim 1, wherein, in the compressed configuration, the contact forces elastically deform, in a radial direction perpendicular to the central axis, firstly at least one of the body of the first connection element and the second connection element and secondly the rod of the first connection element and/or of the second connection element.

4. The connector according to claim 3, wherein, in the compressed configuration, the elastic deformation of the body and of the rod of at least one of the first connection element and the second connection element generates, by elastic return, a radial component for each contact force.

5. The connector according to claim 4, wherein the body of the second connection element is housed, at least partly, in the internal passage of the first connection element and in that the radial component of the resultant of the contact force, at the level of the bodies of the connection elements, is oriented towards the central axis .

6. The connector according to claim 4, wherein a first ratio having as its numerator the intensity of the axial component of one or other of the resultants of the contact forces and as its denominator the total intensity of this resultant of the contact forces, decreases as the second connection element progresses towards the first connection element, while a second ratio having as its numerator the intensity of the radial component of one or other of the resultants of the contact forces and as its denominator the total intensity of this resultant of the contact forces, increases in the same time.

7. The connector according to claim 1, wherein the first contact surface of at least one of the first connection element and the second connection element, as well as the second contact surface of at least one of the first connection element and the second connection element are oblique with respect to the central axis.

8. The connector according to claim 7, wherein the intersection between a plane that comprises the central axis and a plane tangent to each oblique contact surface defines a straight line that forms with the central axis an angle of between 5° and 40°.

9. The connector according to claim 7, wherein the contact surfaces which, in the compressed configuration, come into contact with the oblique contact surfaces, have a radius of curvature of between 0.05 mm and 0.20 mm.

10. The connector according to claim 1, wherein the conductive rod of the first connection element is hollow and in that the conductive rod of the second connection element is housed, at least partly, inside the hollow conductive rod.

11. The connector according to claim 1, wherein the axial component of each contact force is present continuously during connection, as soon as the connector electrically connects the printed circuit boards.

12. The connector according to claim 1, wherein the conductive body of one of the connection elements comprises a stop preventing the conductive body of the other connection element from separating.

13. The connector according to claim 1, wherein the conductive body of at least one of the connection elements is not mechanically fixed to the printed circuit board designed to be put in contact with this connection element.

14. The connector according to claim 1, wherein the conductive body and the conductive rod of at least one of the connection elements are not mechanically integral in translation.

15. The connector according to claim 1, wherein the conductive body of one of the connection elements is adapted to deform elastically, and in that the first contact surface of the other connection element is oblique with respect to the central axis.

16. The connector according to claim 1, wherein the conductive rod of one of the connection elements is adapted to deform elastically, and wherein the second contact surface of the other connection element is oblique with respect to the central axis.

17. The connector according to claim 7, wherein the intersection between a plane that comprises the central axis and a plane tangent to each oblique contact surface defines a straight line that forms with the central axis an angle of between 10° and 35°.

18. The connector according to claim 7, wherein the contact surfaces which, in the compressed configuration, come into contact with the oblique contact surfaces, have a radius of curvature of between 0.15 and 0.1 mm.
